(19) United States
(12) Patent Application Publication
(10) Pub. No.: US 2017/0221315 A1
(43) Pub. Date: Aug. 3, 2017

(54) METHODS FOR CONDUCTING A SYSTEM OF SHADOW WAGERING

(71) Applicant: Lawrence J. Hodgson, Kildeer, IL (US)

(72) Inventor: Lawrence J. Hodgson, Kildeer, IL (US)

(21) Appl. No.: 15/485,898

(22) Filed: Apr. 12, 2017

Related U.S. Application Data
(62) Division of application No. 14/515,824, filed on Oct. 16, 2014.
(60) Provisional application No. 61/892,066, filed on Oct. 17, 2013.

(51) Int. Cl. G07F 17/32

(52) U.S. Cl. CPC G07F 17/3288; G07F 17/323; G07F 17/3244; G07F 17/3223

(57) ABSTRACT

A system and method of conducting a shadow wagering system. The system and method configured to accept a shadow wager having a plurality of shadow wager requirements from a shadow player based upon an outcome of a base game being played by a base player. The base player and the shadow player being different individuals. The system and method being configured to initiate play of the base game, wait for the outcome of the base game, evaluate the outcome of the single play according to the shadow wager requirements, and award the shadow player a prize corresponding to the outcome of the single play if the outcome corresponds to a winning outcome defined by a predetermined set of rules for the base game.

### CROSS REFERENCE TO RELATED APPLICATION

The present application is a divisional of U.S. patent application Ser. No. 14/515,824 filed Oct. 16, 2014, which claims the benefit of U.S. Provisional Patent Application Ser. No. 61/892,066 filed Oct. 17, 2013, all of which are incorporated by reference in their entirety as if fully set forth herein.

### FIELD

The subject invention pertains to allowing the placement of “shadow” wagers based upon the outcome of gambling games by persons not actively participating in the play of the gambling games.

### BACKGROUND

The present subject matter relates generally to a new wagering system and method. Specifically, the present subject matter relates to systems and methods for gambling via shadow wagering.

Casino style games are typically played either in casinos or in legal jurisdictions online. People participate by either physically going to a casino or playing online in jurisdictions without gambling prohibitions. However, physically visiting a casino is not always convenient, or even a viable option. Further, gamblers may not always have time to participate in typical wagering, even in online games.

Accordingly, there is a need for a wagering method that does not require active participation in a game.

### BRIEF DESCRIPTION OF THE DRAWINGS

FIG. 1 shows a configuration of interrelated elements allowing the use of the invention.

### DETAILED DESCRIPTION

The present disclosure provides systems and methods of shadow wagering. Various examples of the systems and methods are provided herein. Additional examples and embodiments of the shadow wagering systems and methods will be apparent to those skilled in the art based on the disclosures provided herein.

Through the systems and methods taught herein, users may place shadow wagers on casino style games from an online electronic device, whether through a website or dedicated mobile application. A shadow wager is defined as a wager that is placed by a first party (referred to as the “shadow player” or “user,”) remotely through an online interface, that is tied to the play of a casino game (referred to as the “base game” and its play as “real-time play”) being played in real-time by a second party (referred to as the “base player” or “real-time player”) that is either: (a) playing from a casino floor; or (b) playing in a legal jurisdiction online. In essence, the systems and methods provided herein enable a user to gamble on casino games without having to be present and without having to follow the game in real-time. It is required that the base game be conducted subject to a reasonable regulatory regime: this allows the shadow player to be assured that the outcome of the base game will be within known and enforced outcome parameters.

The systems and methods allow a shadow player to place one or more shadow wagers using user-defined criteria to identify the type of real-time wagers to shadow. If the shadow player places a wager that matches the shadow wager criteria, the shadow wager is placed. At the conclusion of the real-time play, prizes can be awarded to the user's account.

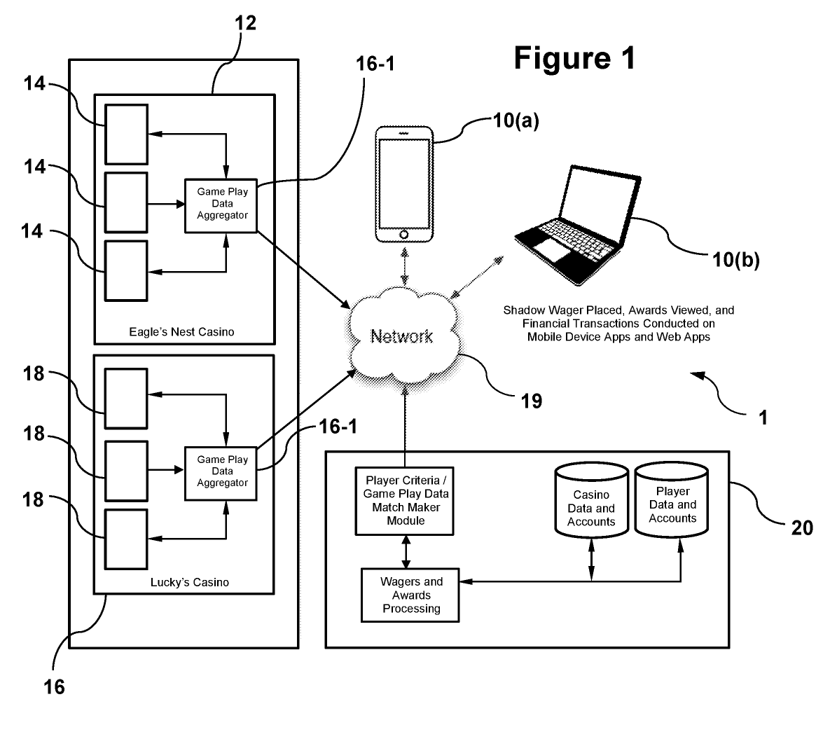

By referring to FIG. 1, the invention and its embodiment may be easily understood. The user (not shown) accesses a shadow wagering system 1 through any reasonable and appropriate device, such as smartphone 10(a) or computer 10(b). After establishing a secure account by any reasonable means, such means being well known in the art, the user inputs their shadow wagering criteria into one of the access devices 10(a), 10(b) and it is transmitted through the global computer network, or a secure private network, or any other reasonable and appropriate means shown as network 19, to the shadow wagering server 20. The shadow wagering server comprises one or more real or virtual computing devices, located and operated in any reasonable and appropriate fashion.

Once the shadow wagering criteria are transmitted to shadow wagering server 20, it can compare the shadow wagering criteria to a list of currently available base games provided by selected casinos or other appropriate providers of reasonably regulated base games. On the basis of such comparison, it can select one or more casinos 12, 16 such as Eagle's Nest Casino 12 or Lucky's Casino 16 and get appropriate base game data through network 19 and game play data aggregator 16-1 from one or more base games such as slot machine 14, 18 which are being played by base players (not shown) in the casino 12, 16.

When the base player completes play upon slot machine 14, Eagle's Nest Casino 12 can send appropriate base game data from slot machine 14 through network 19 to shadow wager server 20, which then processes the base game data against the parameters embodied in the shadow wagering system and the shadow wagering criteria entered by the user. If the base game data indicates that the user has won a prize, that prize is credited to the user's secure account on shadow wagering server 14, and the results can be transmitted back to the device(s) used by the user to access the shadow wagering server 20 (or saved for later response to inquiry by the user through such device(s)).

While the above description sets forth a preferred embodiment by which the invention may be practiced by anyone of reasonable skill in the relevant art, it does not include all possible or reasonable embodiments which might incorporate the invention. Further descriptions of improvements and alternate embodiments are set forth below.

For example, the user may set up one or more shadow wagers relating to any number of criteria including, but not limited to, the specific casino(s), the type of game, the bet level, the percentage the user wishes to shadow, the maximum amount of money the user wishes to spend before automatically stopping or withdrawing, and the time frame, among others.

For example, the user may decide to place a shadow wager on all 200-credit bets played on Lucky 7 Slot games at Eagle's Nest Casino. (All games and casinos referred to herein are hypothetical: any resemblance to actual game names, casino names, or trademarks is coincidental and unintentional.) The user may choose to place a 10% shadow percentage. Therefore, anytime a real-time player places a 200-credit bet on a Lucky 7 Slot game at Eagle's Nest Casino, the user will wager 10% of the 200-credit bet, i.e., 20-credits, and be paid back on awards at 10% of the actual real-time win awarded to the real-time player.

The shadow wagers may be configured, placed, and monitored through online systems, such as websites and/or mobile applications. In addition to communications provided through the online systems, the systems and methods described herein may further include notifications that communicate to the user the status and outcomes of the user's shadow bets. For example, the notification may include one or more of a text message, an email, a phone call, or any other message sent through any other communication mechanism.

Additional parameters for shadow wagering systems may include, but are not limited to, the following examples:
A) User chooses a casino or casinos—Either brick and mortar casinos, internet virtual casinos, or play-for-fun social casinos can be selected, so long as the base game is reasonably regulated.
B) User chooses base game themes (e.g., particular models of software themes on electronic slot machines) to shadow.
C) User chooses base game players (either by classification/parameter or by identifying a specific base player) to shadow.
D) User chooses the base game bet level they wish to shadow.
E) User chooses the maximum amount of money to spend on these wagers before stopping the wagering.
F) User chooses the maximum amount of money to win before stopping the wagering.
G) User chooses a time frame in which to run this shadow wager.
H) User chooses the percent of a credit to wager per wager.

As an example, a user can choose to shadow any 50 credit bets on a particular base game but only wants to shadow 10% of each credit wagered. By choosing 10%, the user will wager 5 credits per each game played—not the entire 50 credits as wagered by the real-time player in the base game.

I) Notification options:
1) Text or email user on larger wins.
2) Text or email user when shadow wager terminates.
3) Text or email user occasion all wager balances.

As noted above, additional examples and embodiments of the shadow wagering systems and methods will be apparent to those skilled in the art based on the disclosures provided herein.

What is claimed is:

1) A method of conducting a shadow wagering system, comprising:
electronically accepting shadow wager criteria from a shadow player located outside a gaming venue, the shadow wager criteria comprising a wagering condition associated with a single play of a base game playable by and in the presence of a base player at a gaming venue;
identifying wagering conditions of a plurality of base games available for play at gaming venues;
comparing the shadow wagering criteria to the wagering conditions associated with a single play carried out on the plurality of available base games;
detecting an outcome of a single play carried out on a base game of the plurality of available base games;
evaluating the outcome according to the shadow wager criteria; and
where the outcome is a predetermined winning outcome and a match is detected between the shadow wager criteria and the wagering condition of a single play carried out on a base game or the plurality of base games, awarding a prize to the shadow player corresponding to a prize awarded to the base player from the predetermined winning outcome.

2) A method of conducting a shadow wagering system as in claim 1, wherein the base game is a regulated gambling game being played in a regulated land-based casino.

3) A method of conducting a shadow wagering system as in claim 1, wherein the base game is a regulated gambling game being played in a regulated casino environment operated through a global computer network.

4) A method of conducting a shadow wagering system as in claim 1, wherein the shadow wager criteria is accepted via a device connected to a global computer network.

5) A method of conducting a shadow wagering system as in claim 2, wherein the shadow wager criteria is accepted via a device connected to a global computer network.

6) A method of conducting a shadow wagering system as in claim 3, wherein the shadow wager criteria is accepted via a device connected to a global computer network.

7) A method of conducting a shadow wagering system as in claim 1, wherein the shadow wager criteria comprises a wager proportional to a base wager placed by the base player on the base game.

8) A method of conducting a shadow wagering system as in claim 2, wherein the shadow wager criteria comprises a wager proportional to a base wager placed by the base player on the base game.

9) A method of conducting a shadow wagering system as in claim 3, wherein the shadow wager criteria comprises a wager proportional to a base wager placed by the base player on the base game.

10) A method of conducting a shadow wagering system as in claim 2, wherein the shadow wager criteria comprises a selection of a particular casino from a plurality of regulated land-based casinos providing a plurality of base games for shadow wagering.

11) A method of conducting a shadow wagering system as in claim 3, wherein the shadow wager criteria comprises a selection of a particular regulated casino environment from a plurality of regulated casino environments providing a plurality of base games for shadow wagering.

12) A method of conducting a shadow wagering system as in claim 1, wherein the shadow wager criteria comprises a selection of a particular base game from a plurality of base games available for shadow wagering.

13) A method of conducting a shadow wagering system as in claim 2, wherein the shadow wager criteria comprises a selection of a particular base game from a plurality of base games available for shadow wagering.

14) A method of conducting a shadow wagering system as in claim 3, wherein the shadow wager criteria comprises a selection of a particular base game from a plurality of base games available for shadow wagering.

15) A system comprising:
an electronic access device having an input device to accept shadow wagering criteria from a location outside a gaming venue, the shadow wager criteria comprising a wagering condition associated with a single play of a base game playable by and in the presence of a base player at a gaming venue;
an electronic server having a programmable processor and control circuitry, the shadow wagering criteria being processed by the server;
an electronic game-play aggregator module;
a plurality of gaming machines operatively connected to the aggregator module, electronic server and access device via a computer network, wherein the system identifies wagering conditions of a plurality of base games available for play at gaming venues, compares the shadow wagering criteria to the wagering conditions associated with a single play carried out on the plurality of available base games, detects an outcome of a single play carried out on a base game of the plurality of available base games, evaluate the outcome according to the shadow wager criteria, and where the outcome is a predetermined winning outcome and a match is detected between the shadow wager criteria and the wagering condition of a single play carried out on a base game or the plurality of base games, awards a prize to the shadow player corresponding to a prize awarded to the base player from the predetermined winning outcome.
